(19) United States
(12) Patent Application Publication
(10) Pub. No.: US 2016/0163057 A1
(43) Pub. Date: Jun. 9, 2016

(54) Three-Dimensional Shape Capture Using Non-Collinear Display Illumination

(71) Applicant: Google Inc., Mountain View, CA (US)

(72) Inventors: Henry Allan Rowley, Sunnyvale, CA (US); Shumeet Baluja, Leesburg, VA (US)

(21) Appl. No.: 14/945,880

(22) Filed: Nov. 19, 2015

Related U.S. Application Data
(60) Provisional application No. 62/087,651, filed on Dec. 4, 2014.

(51) Int. Cl. G06T 7/00; G06T 15/50; H04N 13/02

(52) U.S. Cl. CPC G06T 7/0073; H04N 13/0253; H04N 13/0296; G06T 15/506; G06T 7/002; G06T 2207/10028; G06T 2207/10152

(57) ABSTRACT

Methods, systems, and apparatus, including computer programs encoded on a computer storage medium, for three-dimensional shape capture. In one aspect, a method includes displaying a first, a second and a third illumination patterns on a display screen, and capturing a first, a second and a third image of an object while the first, the second and the third illumination patterns are respectively displayed. The method further includes determining the three-dimensional shape of the object based on the captured images.

### CROSS-REFERENCE TO RELATED APPLICATIONS

This application claims priority under 35 USC §119(e) to U.S. Patent Application Ser. No. 62/087,651 filed on Dec. 4, 2014, the entire contents of which are hereby incorporated by reference.

### BACKGROUND

Photometric stereo is a method for using multiple images of an object in different lighting conditions to reconstruct the three-dimensional (3D) shape of that object. The process is based on a number of assumptions, such as the object position relative to the camera must not move between the images, and that the process follows (at least roughly) a Lambertian lighting model. Such a model is one in which the brightness of a point depends on the angle between the surface of the object and the light source, and not on the angle between the surface and the camera. This model works well for non-shiny objects, for example, faces.

Typically the process is constructed with the assumption that light sources are small point sources far away from the object such that the light rays illuminating the object are parallel to each other. Because light is additive, however, it is possible to deal with area light sources as well, such as by imagining breaking down each light source into points and computing their contribution to the overall brightness of a point on the object.

### SUMMARY

This specification describes technologies relating to three-dimensional shape capture.

In general, one innovative aspect of the subject matter described in this specification can be embodied in a system comprising a camera configured for capturing images, the camera including a lens; a display screen capable of illuminating a plurality of pixels within the display screen; a processor operatively communicating with the camera and the display screen to control the camera and the display screen, the processor being configured to perform operations comprising: receive an input indicative of an initiation of a photometric stereo capture process, and in response: cause the display screen to display a first illumination pattern, wherein the first illumination pattern comprises one or more illuminated portions of the display screen; cause the camera to capture a first image of the particular object illuminated by the display screen displaying the first illumination pattern; cause the display screen to display a second illumination pattern, wherein the second illumination pattern comprises one or more illuminated portions of the display screen; cause the camera to capture a second image of the particular object illuminated by the display screen displaying the second illumination pattern; cause the display screen to display a third illumination pattern, wherein the third illumination pattern comprises one or more illuminated portions of the display screen, wherein the first, second and third illumination patterns are not collinear and wherein a centroid of each illumination pattern is substantially separated from each other centroid of other illuminated patterns; cause the camera to capture a third image of the particular object illuminated by the display screen displaying the third illumination pattern; and determining a three-dimensional shape of the particular object based, at least in part, on the first, second and third images. Other embodiments of this aspect include corresponding method, apparatus, and computer programs, configured to perform the operations of the processor.

In general, another aspect of the subject matter described in this specification can be embodied in a system, comprising: a processor; and a data storage device in data communication with the processor and storing instructions executable by the process and upon such execution cause the processor to perform operations comprising: operatively communicate with a camera and a display screen to control the camera and the display screen; receiving an input indicative of an initiation of a photometric stereo capture process, and in response iteratively capture images of an object, each iterative capture of an image of the object comprising: causing the display screen to display an illumination pattern, wherein the illumination pattern differs from each illumination pattern for each other iteration and wherein a centroid of each illumination pattern is substantially separated from each other centroid of other illuminated patterns; causing the camera to capture an image of the object illuminated by the display screen displaying the illumination pattern; and determining a three-dimensional shape of the object based, at least in part, on each respective image captured during a respective iteration. Other embodiments of this aspect include corresponding methods, apparatus, and computer programs, configured to perform the operations of the processor.

Particular embodiments of the subject matter described in this specification can be implemented so as to realize one or more of the following advantages. Typically, photometric stereo requires an extensive hardware setup, including controlled light sources which are coordinated with the camera taking pictures. This makes it difficult and expensive to use this method. In addition, the need to measure and calibrate the physical geometry of the camera and light sources is challenging. By contrast, the systems and method described in the written description use staple display and camera hardware that is prevalent in many widely available mobile devices, desktops, laptops, and other standard consumer hardware. This reduces the need for special hardware, and eliminates or greatly reduces the complexity of calibration, realizing significant improvements in the technological field. Reduces costs associated with three-dimensional image capturing.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A, 1B and 1C are an example environment in which a mobile device captures a three-dimensional shape of an object.

FIG. 2 is a flow diagram of an example process for capturing a three-dimensional shape of an object.

FIGS. 3A, 3B and 3C are example illumination pattern triplets for capturing a three-dimensional shape of an object.

FIG. 4 is block diagram of an example computer system that can be used to capture three-dimensional shapes of objects.

Like reference numbers and designations in the various drawings indicate like elements.

### DETAILED DESCRIPTION

Overview

The subject matter below relates to capturing three-dimensional shapes. In the examples described, a mobile device is used. However, the subject matter can be implemented in any computer device that is operative associated with a display screen and a camera. For example, the subject matter can be implemented in a game console that controls a smart television mounted with a camera; or in a laptop computer with an integrated camera, or in other systems, whether such systems are integrated in a single device or a combination of devices that are controlled by a computer device.

A variety of different methods may be used to capture three-dimensional shapes, using mobile devices. For example, photometric stereo is a method for using multiple images of an object under different lighting conditions and, in turn, use the captured images to reconstruct the three-dimensional shape of the object.

In some implementations, it is assumed that the object is stationary while the multiple images are captured. It is also assumed, in some implementations, that the objects at least marginally follow a Lambertian lighting model. The Lambertian lighting model provides that the brightness of a point on the object depends on the angle between the surface of the object and the light source, and that the brightness of the point is independent from the angle between the surface and the camera capturing the images of the object. This lighting model is well suited for a variety of objects, such as faces. In some implementations, lighting is modeled as a plurality of small light sources that are far from the object, such that light rays illuminating the object are substantially parallel to one another. The assumptions and modeling parameters discussed above with respect to certain implementations reduce the complexity associated with capturing a three-dimensional shape. In turn, such implementations are simplified and require less operations and processing power to realize.

In the examples described below, a system is used to capture at least three images of an object under different lighting conditions. The lighting conditions are controlled by displaying illumination patterns on a display screen to illuminate an object being modeled. The display screen is used to generate the required lighting environment for the capture of each image. The illumination pattern for each image that is captured is different from each other illumination pattern. Furthermore, centroids of each illumination patterns are non-collinear. The captured images are then used to reconstruct the three-dimensional shape of the object. The derivation of the three-dimensional shape can be realized by photometric reconstruction, a process which uses the captured images to determine constraints for a linear system of equations. Solving the linear system of equations provides the normal vector of each point on the surface of the object.

These operations are described in more detail below.

Example Operating Environment

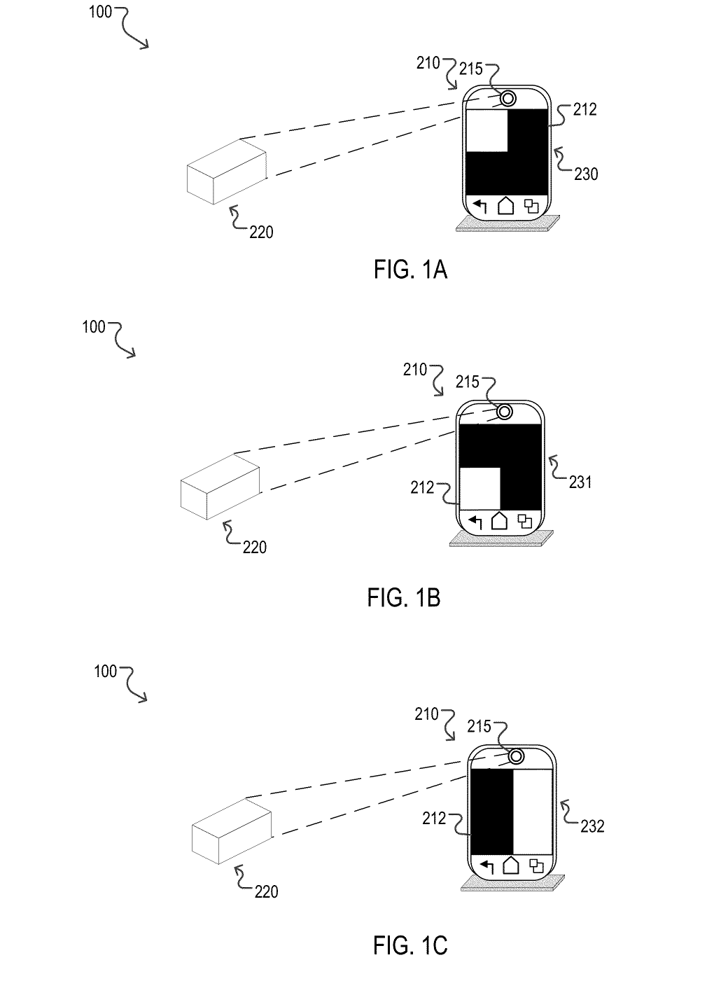

FIGS. 1A, 1B and 1C are an example environment in which a mobile device captures a three-dimensional shape of an object. Device 210 is used to capture the three-dimensional shape of object 220. In some implementations, device 210 is a mobile phone or a laptop computer. In other implementations, device 210 is a stationary device capable of capturing images, and connected to a display screen. For example, device 210 may be a camera for gesture based control of television. Other devices that control or include a camera and a display screen may also be used.

The mobile device 210 is equipped with a camera, as indicated by the camera lens 215. The mobile device 210 is secured in a stationary position before the three-dimensional capture operations are started. The mobile devices 210 displays a first illumination pattern 230 on mobile device's display screen 212. In some implementations, the illumination pattern may also utilize a camera flash on the mobile device to create the first illumination pattern, in combination with the first display screen. In some implementations, the flash light may be configured to turn on for the entire duration the first illumination pattern is displayed. Once the first light pattern is displayed, the camera 215 captures a first image of object 220. The image may be stored for later retrieval, e.g., in memory on the mobile device or in a cloud based service.

After capturing the first image, a second illumination pattern 231 is displayed on the display screen of mobile device 210. The mobile device 210 is in the same position relative to the object 220 in FIG. 1A as in FIG. 1B. Once the second illumination pattern is displayed, the camera 215 captures a second image of object 220. The image may be stored for later retrieval as described above. Similarly, a third illumination pattern 232 is displayed on the display screen of mobile device 210. Once the third illumination pattern is displayed, the camera 215 captures a third image of object 220. Again, the mobile device 210 is in the same position relative to the object 220 in FIG. 1A, FIG. 1B and FIG. 1C.

In some implementations, additional images may be captured by mobile device 210. For example, a fourth image may be captured using a fourth illumination pattern and stored similar to the first, second and third image. The images are then used to determine constraints for the linear system of equations of photometric reconstruction. The normal vector for each point on the surface of the object 220 is calculated by solving the linear system of equations. This allows the mobile device to reconstruct the three-dimensional shape of the object 220 based on, at least, the first, second and third captured images.

Each illumination pattern includes one or more illuminated portions of the display screen 230. The one or more illuminate portions create the illumination pattern. In some implementations, the illumination patterns are not collinear (e.g., the respective centroids of each illumination pattern do not define a straight line). In some implementations, each illumination pattern is substantially separated from each other illumination pattern (e.g., the respective centroids of each illumination pattern are substantially separated). As used in this specification, “substantially separated” means that centroid of each illumination pattern are separated by a distance from one another such that the resulting images yield sufficient data to generate the 3D surface models. Substantial separation is thus pattern and intensity dependent, and may be derived, for example, from empirical testing. In some implementations, the illumination patterns are provided to the mobile device by a third party, for example, a publisher of the software used to capture the images and render the 3D models as described in this written description.

Example Process for Capturing a Three-Dimensional Image

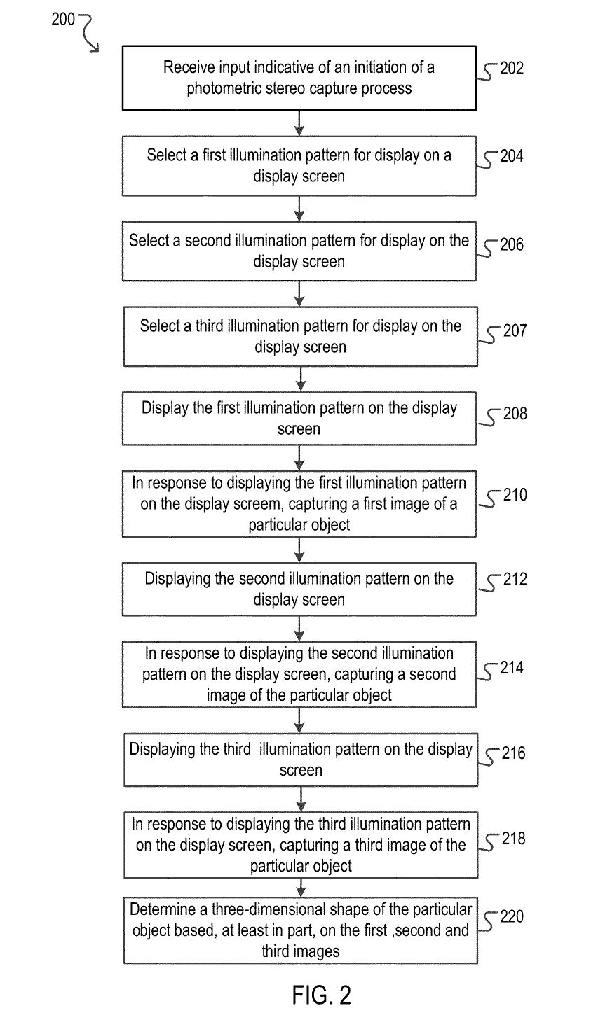

FIG. 2 is a flow diagram of an example process for capturing a three-dimensional shape of an object. The process 200 can be implemented in a data processing apparatus, such as one or more computers.

The process 200 starts with receiving input indicative on an initiation of photometric stereo capture process (202). The process may be initiated by, for example, using a touch screen interface.

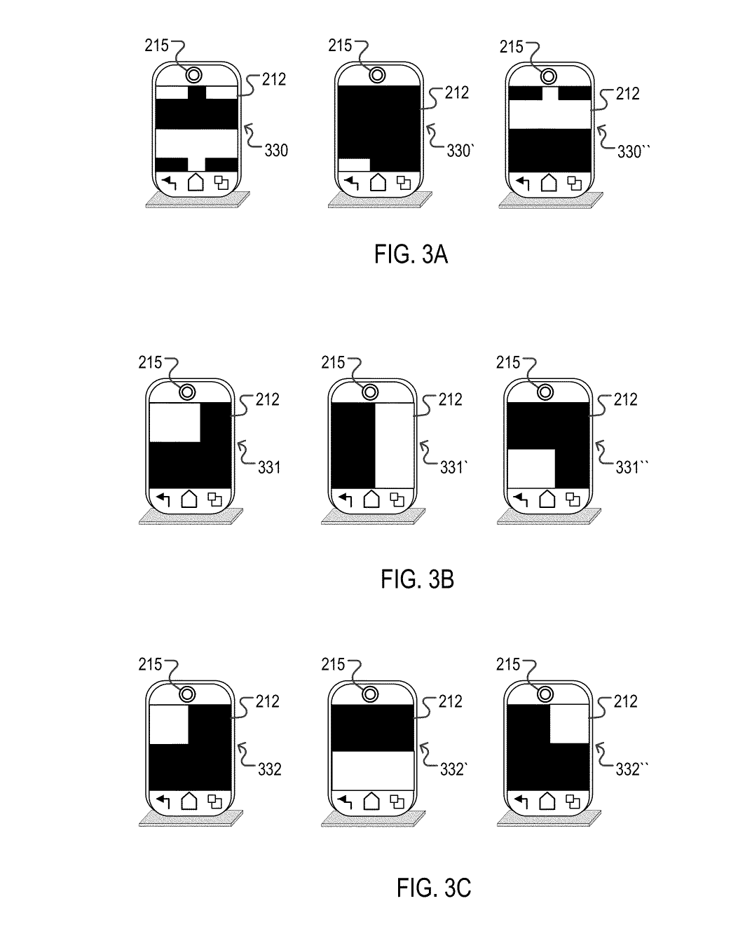

The process 200 then continues with selecting a first illumination pattern for display on a display screen of the device (204). The process 200 also selects a second illumination pattern for display on the display screen of the device (206). The process 200 also selects a third illumination pattern for display on the display screen of the device (207). In some implementations, the first, second and third illumination patterns are orthogonal. In some implementations, the first, second and third illumination patterns do not include overlapping portions. In some implementations, the three illumination patterns are not collinear, and each illumination pattern is substantially separated from each other illumination pattern as described above. Example illumination patterns are described with reference to FIG. 3.

The process 200 continues by displaying the first illumination pattern on the display screen (208). While the first illumination pattern is displayed on the display screen, the process 200 continues by capturing a first image of an object (210). The displayed illumination pattern creates a particular lighting environment that illuminates the object. The first image is captured under the particular lighting environment generated by the displaying of the first illumination pattern on the display screen.

The process 200 continues with displaying the second illumination pattern on the display screen (212). While the second illumination pattern is displayed on the display screen, the process 200 continues by capturing second image of a particular object (214). The second image is captured under the different lighting environment generated by the displaying of the second illumination pattern on the display screen. The displayed illumination pattern for the second illumination pattern creates a lighting environment illuminating the object that is different from the lighting environment created by the first illumination pattern. For each image capture, the device is in a same position relative to the object. For example, the device may be seated in a stationary cradle or a dock while the first and second images are being captured.

The process 200 continues with displaying the third illumination pattern on the display screen (216). While the third illumination pattern is displayed on the display screen, the process 200 continues by capturing a third image of the particular object (218). The third image is captured under the different lighting environment generated by the displaying of the third illumination pattern on the display screen. The displayed illumination pattern for the third illumination pattern creates a lighting environment illuminating the object that is different form the lighting environment created by the first and second illumination pattern. For each image capture, the device is in a same position relative to the object. For example, the device may be seated in a stationary cradle or a dock while the first and second images are being captured, as described above.

In some implementations, the process may capture an additional image of the object with the illumination off, to measure the background illumination. The background illumination may include illumination caused by external light sources such as street lights or sun light. The image of the object (214) may be subtracted from the images captured under the illumination patterns, to further isolate the effect of the controlled illumination. In some implementations, automatic brightness controls on the capturing camera may be disabled to achieve a higher consistency between images captured.

Finally, the process 200 ends with determining a three-dimensional shape of the particular object based, at least in part, on the first, second and third images 220. For example, the images may be used to determine constraints for the linear system of equations of photometric reconstruction, as described above. A variety of appropriate photometric reconstruction processes can be used. For example, a reconstruction process may determine a normal vector for each point on the surface of the object by solving a linear system of equations. From this set of normal vectors, the 3D coordinates of each point can be reconstructed using photometric stereo techniques. In some implementations, the determined three-dimensional shape of the object is stored locally on the device. In alternative implementations, the determined three-dimensional shape of the object is transferred to a different device for storage.

Although only three images are captured, the process 200 can be extended to multiple iterations, where each iteration has an illumination pattern that is different from each other illumination pattern.

Illumination Patterns

A variety of different illumination patterns may be suitable for capturing the first and second images described above. FIGS. 3A, 3B, and 3C are example illumination pattern triplets for capturing a three-dimensional shape of an object, using a mobile device. As previously described, photometric stereo relies on images of an object in different lighting conditions to reconstruct a three-dimensional shape of the object. In some implementations, the different lighting conditions must vary from one another in order to obtain satisfactory results.

In some implementations, illumination pattern triplets are completely orthogonal. Orthogonal illumination pattern triplets are triplets of images in which the respective illuminated portions on the screen in a first pattern do not overlap with respective illuminated portions in the second pattern. For example, FIG. 3A provides a first illumination pattern 330 that is orthogonal to a second illumination pattern 330′ and a third illumination pattern 330″. The illuminated portions of illumination patterns 330, 330′ and 330″ do not overlap. Capturing the first, second and third images while displaying the illumination patterns 330, 330′ and 330″ respectively, provides three distinctly different lighting conditions for the image capture.

In some implementations, the illumination pattern triplets may be semi-orthogonal. For example, illumination patterns 331, 331′ and 331″ are semi-orthogonal. Semi-orthogonal illumination pattern triplets are pattern triplets where the illuminated portions of three illumination patterns of the display screen do not overlap for the majority of the patterns. For example, a minor overlap may occur in small portions of the illumination patterns. In some implementations, semi-orthogonal illumination pattern triplets must not overlap in an area larger than a particular threshold. For example, an illumination pattern triplet is semi orthogonal only if the overlap between the triplets does not exceed a pre-specified threshold. In some implementations, the threshold is defined as an area. In alternative implementations, the threshold is defined as a percentage of the overall display screen. For example, an illumination pattern triplet is semi-orthogonal if the illuminated portions of each pattern overlap at less than 10% of the display screen. This ensures that the three lighting conditions are substantially different from one another.

FIG. 3C shows an illumination pattern triplet where the illumination patterns are orthogonal and non-collinear. In some implementations, collinear patterns and non-orthogonal triplets may be used. However, using non-collinear patterns and orthogonal triplets may require a smaller number of image captures to complete photometric three-dimensional reconstruction.

Additional Device Configurations and Calibration

Other implementations may include a processing device that is operatively associated with a camera device and a display device that are both separate devices from the processing device. For example, a processing device can communicate with the smart television and a camera, and a person (or other object) can be placed in front of the smart television and illuminated for imaging.

In some implementations, prior to the iterative capturing of images of the object, the system may perform a calibration process. For example, the processing device may cause the display screen to display calibration instructions (e.g., instructions that can be read by the user and solicit user interactions). In response to user actions, the system receives calibration data from the camera and the display device, and performs a calibration operation based on the calibration data to calibrate the display screen and the camera for the photometric stereo capture process.

For example, the calibration instructions may result in the system determining a location of the camera relative to the display screen, e.g., behind, in front of, by the side of the display. Likewise, the calibration instructions may result in a calibration operation that determines a location of the display screen relative to a calibration object in front of the display screen, e.g., a color card, etc. The calibration operation may also instruct a user to place an object a certain distance from both the camera and the display screen. Other calibration operations may include taking ambient lighting readings, for example, to calibrate the intensity of the illuminated portions of the illumination patterns.

In some implementations, the relative position of the camera relative to the display screen is fixed for particular models of mobile devices comprising a display screen and a camera (e.g. mobile phones, laptops, etc . . . ). The calibration information for each model could be stored, for example, at a cloud server, for later retrieval by other devices of the same model. This eliminates the need to calibrate other devices of the same model, since the calibration information for that device model can be fetched from the cloud server.

Additional Implementation Details

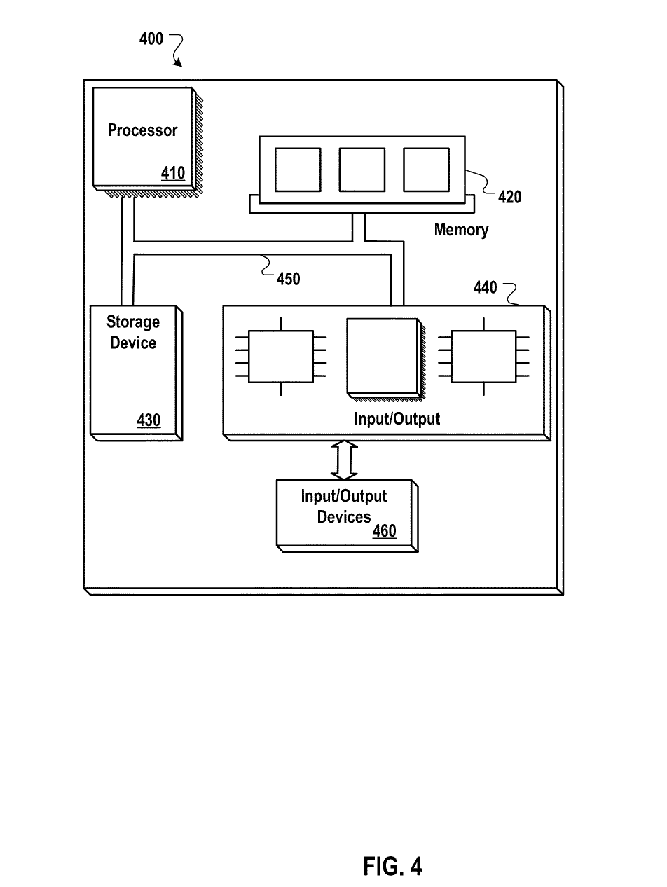

FIG. 4 is a block diagram of an example computer system 400 that can be used to capture three-dimensional shapes of objects. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface device, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
a camera configured for capturing images, the camera including a lens;
a display screen capable of illuminating a plurality of pixels within the display screen;
a processor operatively communicating with the camera and the display screen to control the camera and the display screen, the processor being configured to perform operations comprising:
receive an input indicative of an initiation of a photometric stereo capture process, and in response:
cause the display screen to display a first illumination pattern, wherein the first illumination pattern comprises one or more illuminated portions of the display screen;
cause the camera to capture a first image of the particular object illuminated by the display screen displaying the first illumination pattern;
cause the display screen to display a second illumination pattern, wherein the second illumination pattern comprises one or more illuminated portions of the display screen;
cause the camera to capture a second image of the particular object illuminated by the display screen displaying the second illumination pattern;
cause the display screen to display a third illumination pattern, wherein the third illumination pattern comprises one or more illuminated portions of the display screen, wherein the first, second and third illumination patterns are not collinear and wherein a centroid of each illumination pattern is substantially separated from each other centroid of other illuminated patterns;
cause the camera to capture a third image of the particular object illuminated by the display screen displaying the third illumination pattern; and
determining a three-dimensional shape of the particular object based, at least in part, on the first, second and third images.

2. The system of claim 1, wherein the operations further comprise constructing a three-dimensional model of the particular object based on the determination.

3. The system of claim 1, wherein the camera, display screen and the processor are integrated into a single device, the lens and the display screen being on a same side of the device.

4. The system of claim 3, wherein the single device is a smart phone.

5. The system of claim 1, wherein the first, second and third light patterns are orthogonal.

6. The system of claim 1, wherein the operations further comprise capturing a no-illumination image wherein the no-illumination image is different for the first, second and third images.

7. A system, comprising:
a processor; and
a data storage device in data communication with the processor and storing instructions executable by the process and upon such execution cause the processor to perform operations comprising:
operatively communicate with a camera and a display screen to control the camera and the display screen;
receiving an input indicative of an initiation of a photometric stereo capture process, and in response iteratively capture images of an object, each iterative capture of an image of the object comprising:
causing the display screen to display an illumination pattern, wherein the illumination pattern differs from each illumination pattern for each other iteration and wherein a centroid of each illumination pattern is substantially separated from each other centroid of other illuminated patterns;
causing the camera to capture an image of the object illuminated by the display screen displaying the illumination pattern; and
determining a three-dimensional shape of the object based, at least in part, on each respective image captured during a respective iteration.

8. The system of claim 7, the operations further comprising:
prior to the iterative capturing of images of the object:
causing the display screen to display calibration instructions;
receiving calibration data from the camera and the display device in response to one or more user inputs solicited by the calibration instructions;
performing a calibration operation based on the calibration data to calibrate the display screen and the camera for the photometric stereo capture process.

9. The system of claim 8, wherein performing a calibration operation comprise determining a location of the camera relative to the display screen.

10. The system of claim 8, wherein performing a calibration operation comprise determining a location of the display screen relative to a calibration object in front of the display screen.

11. The system of claim 8, wherein each illumination pattern is orthogonal to each other illumination pattern.

12. A computer-implemented method, comprising:
causing, by a computer device, a display screen to display a first illumination pattern;
causing, by the computer device, a camera to capture a first image of an object illuminated by the display screen displaying the first illumination pattern;
causing, by a computer device, the display screen to display a second illumination pattern, wherein the second illumination pattern is different from the first illumination pattern;
causing, by a computer device, the camera to capture a second image of the object illuminated by the display screen displaying the second illumination pattern;
causing, by a computer device, the display screen to display a third illumination pattern, wherein the third illumination pattern comprises one or more illuminated portions of the display screen, wherein the first, second and third illumination patterns are not collinear and wherein a centroid of each illumination pattern is substantially separated from each other centroid of other illuminated patterns;
causing the camera to capture a third image of the particular object illuminated by the display screen displaying the third illumination pattern; and
determining a three-dimensional shape of the object based, at least in part, on the first and second images.

13. The computer-implemented of claim 12, wherein the operations further comprise constructing a three-dimensional model of the particular object based on the determination.

14. The computer-implemented method of claim 12, wherein the first and second light patterns are orthogonal.

15. A computer-implemented method, comprising:
causing, by a computer device, a display screen to iterative display illumination patterns, wherein for each iteration the illumination pattern differs from each illumination pattern for each other iteration and wherein a centroid of each illumination pattern is substantially separated from each other centroid of other illuminated patterns for other iterations;
causing, by the computer device and for each iteration, a camera to capture an image of the object illuminated by the display screen displaying the illumination pattern; and
determining a three-dimensional shape of the object based, at least in part, on each respective image captured during a respective iteration.

16. The computer-implemented method of claim 15, the operations further comprising:
prior to the iterative displaying of illumination patterns:
causing the display screen to display calibration instructions;
receiving calibration data from the camera and the display device in response to one or more user inputs solicited by the calibration instructions; and
performing a calibration operation based on the calibration data to calibrate the display screen and the camera for the photometric stereo capture process.

17. The computer-implemented method of claim 16, wherein performing a calibration operation comprise determining a location of the camera relative to the display screen.

18. The computer-implemented method of claim 16, wherein performing a calibration operation comprise determining a location of the display screen relative to a calibration object in front of the display screen.

19. The computer-implemented method of claim 15, wherein each illumination pattern is orthogonal to each other illumination pattern.
